(19) United States
(12) Patent Application Publication
(10) Pub. No.: US 2007/0193108 A1
(43) Pub. Date: Aug. 23, 2007

(54) Mouse trap

(76) Inventor: Bradley Scott Gordon, Whittier, CA (US)

Correspondence Address: P.Jeff Martin of The McGougan Law Firm, LLC;Suite 200, 2120 Sea Mountain Hwy., P.O. Box 4369, N. Myrtle Beach, SC, 29597, US

(21) Appl. No.: 11/700,587

(22) Filed: Jan. 31, 2007

Related U.S. Application Data
(60) Provisional application No. 60/774,713, filed on Feb. 17, 2006.

(51) Int. Cl. A01M 23/26

(52) U.S. Cl. 43/88

(57) ABSTRACT

An animal trap is provided which includes spring-loaded cupped members for grasping an animal. The cupped members include two sets of opposed arms which are connected in a manner so as to move in unison. The cupped members are biased to a closed position and a trigger holds the cupped members apart to allow entry by an animal. The trigger may slip, break, or be eaten through to release the cupped members. The cupped members enclose an animal when the trigger is released.

### RELATED APPLICATIONS

This application claims the benefit of U.S. Provisional Application No. 60/774,713 filed on Feb. 17, 2006.

### BACKGROUND OF THE INVENTION

1. Field of the Invention

The present invention relates generally to animal control and, more particularly, to animal traps.

2. Description of the Related Art

A variety of mouse traps are known and commonly used. These mouse traps vary from the spring loaded trap which slams a bar against an unsuspecting mouse to various live capture traps. The spring loaded bar traps have the disadvantages ranging from the releasing of fluids (for example, blood) from a dead mouse, to difficulty in setting. Blood, or any other fluid from a mouse, may present health hazards, and is visually unpleasant. Setting or resetting a spring loaded bar trap may result in accidental release of the bar and a painful impact with a finger. Further, many people are not comfortable with killing an animal, even a mouse, and object to the use of traps which kill versus capture. Other people object to the possibility of an injury which leads to a slow drawn out death. For all of these reasons, many people object to the use of a spring loaded bar trap.

Live capture traps are known which lure a mouse, or other animal, into an enclosure, and prevent the exit. While these generally avoid killing the animal, they may hold an animal for a long period of time, and if unattended may result in unintended death. They also may be more costly, and less likely to be acquired.

Accordingly, a need has arisen for an animal trap adapted to capture an animal without causing harm, injury, or death thereto in a manner which is quick, easy, and efficient. The development of the mouse trap fulfills this need.

A search of the prior art did not disclose any patents that read directly on the claims of the instant invention; however, the following references were considered related.

The following patents disclose various animal and/or rodent traps:

U.S. Pat. No. 4,109,407, issued in the name of Johnson;

U.S. Pat. No. 4,570,375, issued in the name of Stroklund;

U.S. Pat. No. 6,415,544, issued in the name of Leyerle et al.;

U.S. Pat. No. 4,803,799, issued in the name of Vajs et al.;

U.S. Pat. No. 3,918,195, issued in the name of Benson et al.;

U.S. Pat. No. 4,630,391, issued in the name of Meyers et al.;

U.S. Pat. No. 4,662,102, issued in the name of Marcolina;

U.S. Pat. No. 4,416,081, issued in the name of Askins;

U.S. Pat. No. 4,766,693, issued in the name of Splawinski;

U.S. Pat. No. 4,462,181, issued in the name of Broman;

U.S. Pat. No. 4,733,494, issued in the name of Johnson et al.;

U.S. Pat. No. 5,295,323, issued in the name of Fasulkey et al.;

U.S. Pat. No. 4,183,165, issued in the name of Swanson;

U.S. Pat. No. 4,127,959, issued in the name of Loeffler,

U.S. Pat. No. 6,910,299, issued in the name of Butera et al.; and

U.S. Pat. No. 6,732,471, issued in the name of Draper.

U.S. Patent application no. 20030014902, published in the name of Draper discloses an animal trap comprised of at least one base member for contact with the ground, at least one frame member pivotally arranged with respect to at least one base member and a release mechanism for holding, in use, at least one frame member under tension above ground. Netting is attached to at least one frame member so that when release mechanism is tripped by animal entering trap, at least one frame member pulls netting over animal as at least one frame member falls to the ground when tension is released.

Internet publication advertisements featuring animal traps for the general purpose/use of capturing and/or killing various types of animals include the following:

http://www.animal-traps.com;

http://www.livetrap.com;

http://www.doityourself.com/icat/springloadtrap;

http://www.doyourownpestcontrol.com/ratsnap.htm;

http://www.flemingoutdoors.com/traps.htm;

http://lawn-and-garden.hardwarestore.com/79-504-animal-traps.aspx;

http://www.forestry-suppliers.com/drilldown_pages/view_category; and

http://www.enasco.com/farmandranch/ProductDetail.do?sku=C13376N.

Consequently, a need has been felt for an animal trap adapted to capture an animal without causing harm, injury, or death thereto in a manner which is quick, easy, and efficient.

### SUMMARY OF THE INVENTION

Therefore, it is an object of the present invention to provide an animal trap having spring-loaded cupped members adapted to securely hold an animal without causing harm, injury, or death thereto.

It is another object of the present invention to provide opposing cupped members which are biased to a closed position.

It is another object of the present invention to provide a trigger adapted hold opposing cupped members in an opened position.

It is another object of the present invention to provide an adjustment mechanism adapted for selectively controlling the diametrical measure of displacement of the cupped members or arms in the closed position, thereby allowing user to control whether a captured animal is deprived of life or harmlessly captured.

Briefly described according to one embodiment of the present invention, an animal trap is disclosed, wherein animal trap includes spring-loaded cupped members for grasping an animal, particularly a rodent, such as a mouse. The cupped members are preferably two sets of opposed arms and the arms in each set of arms are connected to move in unison. The cupped members may also be solid cups. The cupped members are biased towards a closed position and a trigger holds the cupped members apart to allow entry by an animal. The trigger may slip, break, be stepped on, or be eaten through to release the cupped members. The cupped members close around an animal when the trigger is released.

In accordance with one aspect of the invention, there is provided an animal trap comprising opposing cupped members, a hinge for at least one of the cupped members, a spring biasing the cupped members toward a closed position, and a trigger holding the cupped members open. Releasing the trigger allows the cupped members to snap to the closed position. An adjustment mechanism provides a means for adjustably setting hinged displacement of cupped members between an opened position and a closed position.

The use of the present invention allows for the capture of an animal or rodent without causing harm, injury, or death thereto.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of an animal trap, according to the preferred embodiment of the present invention;

FIG. 2 is a perspective view of the animal trap illustrating the curved arms, according to a second embodiment of the present invention;

FIG. 3 is a perspective view of the animal trap illustrating opposing one-piece jaws, according to a third embodiment of the present invention;

FIG. 4 is a perspective view of a fourth embodiment of the present invention illustrating a single hinge and an adjustable closing force;

FIG. 5A is an end view of a fifth embodiment of the present invention;

FIG. 5B is a top view of the fifth embodiment of the present invention;

FIG. 5C is an end view of the fifth embodiment of the present invention showing trigger held horizontally between opposing arms;

FIG. 6 an end view of the fifth embodiment of the present invention showing the arms in a closed position; and

FIG. 7 is an end view of the fifth embodiment of the present invention showing a closure limiting screw.

### DESCRIPTION OF THE PREFERRED EMBODIMENT

### 1. Detailed Description of the Figures

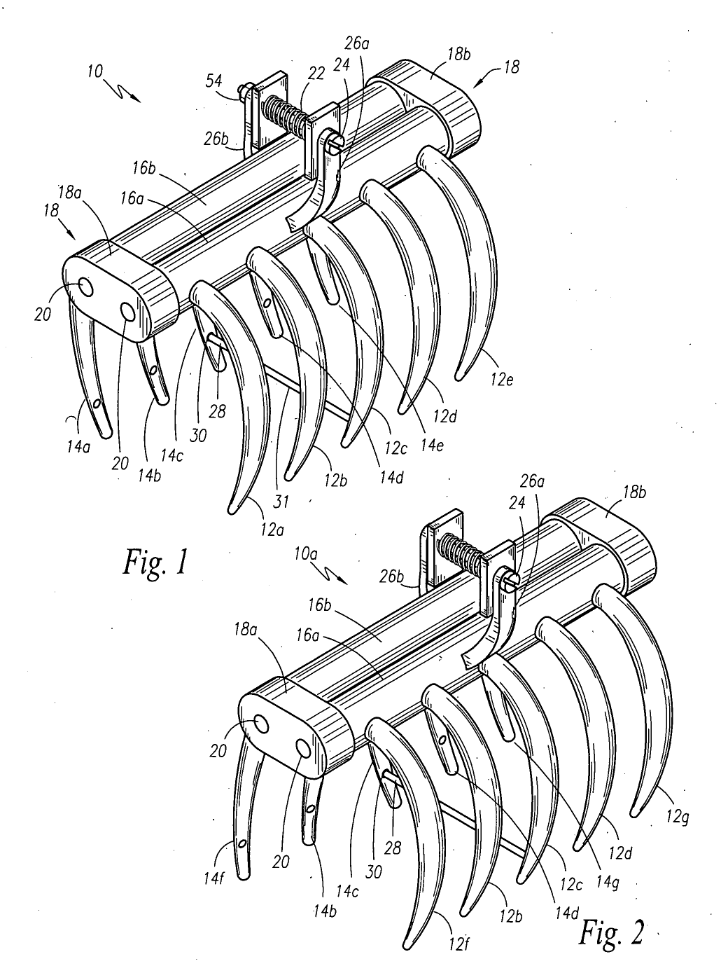

Referring now to FIG. 1, an animal trap 10 is shown, according to the present invention, which includes cupped members 12 and 14 comprising two sets of arms 12a-12e and 14a-14e, respectively. Each set of arms 12a-12e and 14a-14e are attached to backbones 16a and 16b, respectively. The backbones 16a and 16b are adjacently positioned and are preferably solid. Backbone 16a is adapted to cause arms 12a-12e to open or close together, and backbone 16b is adapted to cause arms 14a-14e to open or close together.

The set of arms 12a-12e and 14a-14e are hinged via hinges 18 to allow the opening and closing thereof. The hinges 18 comprise end pieces 18a and 18b between which backbone 16a and backbone 16b are hingedly mounted via pins 20. While two hinges 18 are illustrated in FIG. 1, a single hinge may also be used.

A limiting or adjustment mechanism 21 is provided, wherein adjustment mechanism is adapted to bias arms 12a-12e and 14a-14e towards a closed position. Adjustment mechanism 21 also provides a means for adjustably setting hinged displacement of arms 12a-12e and 14a-14e between an opened position and a closed position. More specifically, adjustment mechanism 21 is adapted for selectively controlling a diametrical measure of displacement of the arms 12a-12e and 14a-14e in the closed position. Thus, adjustment mechanism 21 allows user to control whether captured animal is deprived of life or harmlessly captured.

The adjustment mechanism 21 comprises levers 26a and 26b which are attached to backbones 16a and 16b, respectively. It is envisioned that levers 26a and 26b may alternately be attached to one of arms 12a-12e and 14a-14e, respectively.

The adjustment mechanism 21 further comprises a spring 22 which is suitably held between levers 26a, 26b, thereby facilitating cooperation of the levers 26a, 26b and spring 22 to bias the arms 12a-12e and 14a-14e towards a closed position. In this manner, the levers 26a, 26b bias the arms 12a-12e and 14a-14e into a closed position. The spring 22 is captive over a screw 24. Screw 24 provides a means for adjustably setting hinged displacement of arms 12a-12e and 14a-14e between an opened position and a closed position. More specifically, screw 24 selectively controls a diametrical measure of displacement of the arms 12a-12e and 14a-14e in the closed position. The screw 22 threadedly engages a nut 54 being mounted behind lever 26b. The screw 22 is advanced into nut 54 in order to allow a greater diametrical measure of displacement of the arms 12a-12e and 14a-14e upon closing of the animal trap 10, or screw 22 is withdrawn from the nut 54 to reduce the diametrical measure of displacement of the arms 12a-12e and 14a-14e upon closing of the animal trap 10. The animal trap 10 is therefore selectively adjustable to limit injury to an animal (not shown) caught therein.

A trigger 28 is shown held horizontally between opposing arms 12c and 14c, but may be held between any opposing pair of arms 12a-12e and 14a-14e. Each end of trigger 28 resides in a dimple 30 formed along an inner sidewall of each of the set of arms 12a-12e and 14a-14e in order to provide trigger 28 with a stable position. Trigger 28 is shown in FIG. 1 as a linearly-elongated, rigid member 31. However, trigger 28 may be any structure configured and adapted for holding the set of arms 12a-12e and 14a-14e in an opened position which is releasable when an animal is positioned between the arms 12a-12e and 14a-14e and causes contact or engagement therewith. Preferably, cupped members 12 and 14 are released to a closed position when trigger 28 slips, breaks, or is eaten through.

Referring now to FIG. 2, a second embodiment of the animal trap 10a is provided having curved arms 12f, 12g, 14f, and 14g replacing arms 12a, 12e, 14a, and 14e, respectively of FIG. 1. Arms 12f, 12g, 14f, and 14g define a greater curvature than arms 12a, 12e, 14a, and 14e. Arms 12f, 12g, 14f, and 14g are useful to prevent harm to an animal because center arms 12b, 12c, 12d, 14b, 14c, and 14d require less closure space to trap an animal therebetween.

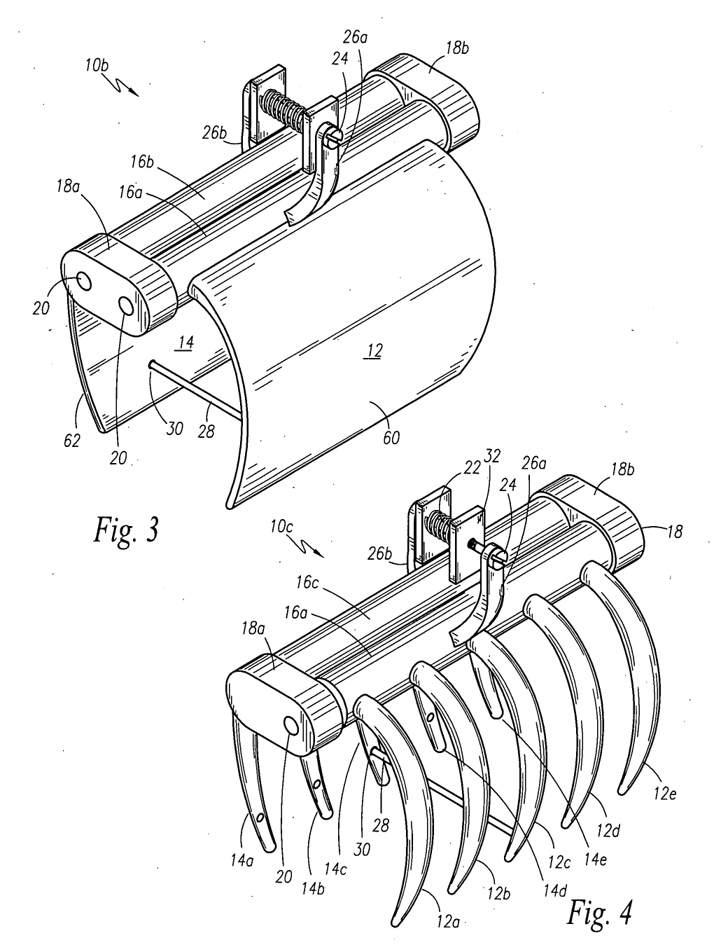

Referring now to FIG. 3, a third embodiment of the animal trap 10b is provided, wherein opposing cupped members 12 and 14 are each defined of a one-piece jaw 60 and 62, respectively. Each jaw 60, 62 defines an arcuate shape. Jaws 60 and 62 may be clear or opaque, or may be fabricated so as to be available in a variety of colors.

Referring now to FIG. 4, a fourth embodiment of the animal trap 10c is provided, wherein trap 10 includes a single hinge 18 comprising backbones 16a and 16c. The hinge 18 comprises end pieces 18a and 18b between which backbone 16a is hingedly mounted via a pin 20. Backbone 16c is fixedly mounted between end pieces 18a and 18b, adjacent to backbone 16a. Spring 22 is mounted between lever 26b and an adjustable stop 32. Spring 22 is adjusted by screw 24 in order to selectively adjust the closing force of arms 12a-12e and 14a.

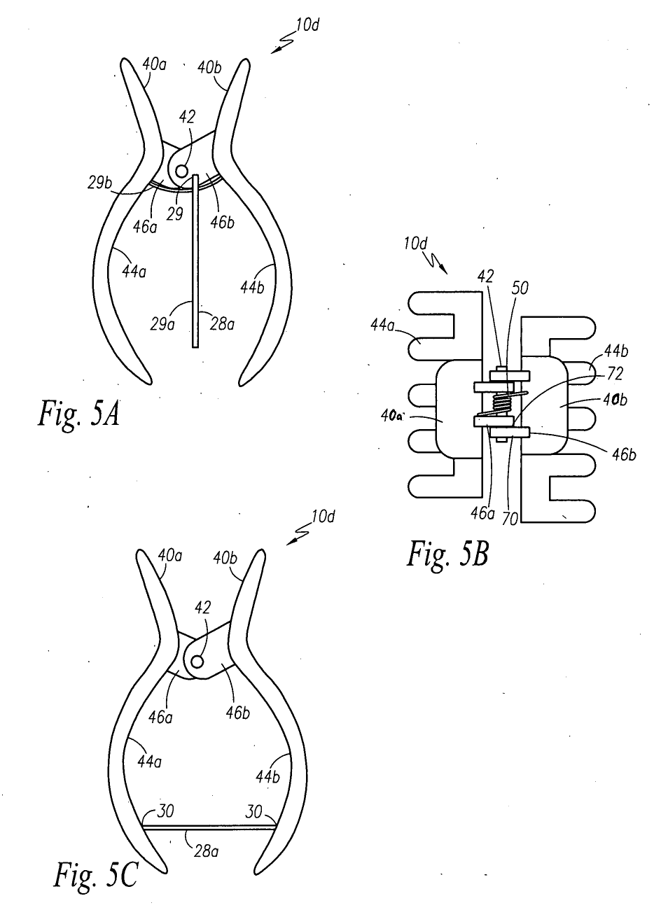

FIG. 5A illustrates an end view of a fifth embodiment of the animal trap 10d, and FIG. 5B illustrates a top view thereof. The trap 10d includes opposing arms 44a and 44b for securely holding an animal therebetween. The arms 44a and 44b extend upwardly into levers 40a and 40b, respectively. The arms 44a and 44b are connected by hinge portions 46a and 46b, respectively. A pin 42 extends through the hinge portions 46a and 46b, and a spring 50 resides over the pin 42. The spring 50 is adapted to bias the arms 44a and 44b into a closed position. A trigger 28a is provided and adapted for holding the arms 44a and 44b in an opened position. The trigger 28a is releasable when an animal is positioned between the arms 44a and 44b and contacts or engages trigger 28a, thereby actuating arms 44a and 44b into a closed position. The trigger 28a defines a finger 29 and an integral, elongated stem 29a extending perpendicularly therefrom. Below finger 29 lies an arcuate-shaped brace 29b molded integral to said stem 29a. The finger 29 of trigger 28a is adapted to be inserted within an aperture 70 defined through hinge portion 46b. Opposing ends of brace 29b are adapted to engage an inner sidewall of arms 44a and 44b, respectively. The brace 29b of trigger 28a functions to temporarily lock arms 44a and 44b in an opened position. Contact or engagement by an animal with trigger 28a actuates the release of finger 29 from aperture 70, and actuates disengagement by said brace 29b from said opposing arms 44a and 44b, thereby causing spring 50 to immediately bias arms 44a and 44b into a closed position.

Alternatively, it is envisioned that trigger 28a may be held horizontally between opposing arms 44a and 44b, as shown in FIG. 5C. Each end of trigger 28a resides in a dimple 30 formed along an inner sidewall of arms 44a and 44b in order to provide trigger 28a with a stable position. The arms 44a and 44b are released to a closed position when trigger 28a slips, breaks, or is eaten through, or is engaged or contacted by an animal.

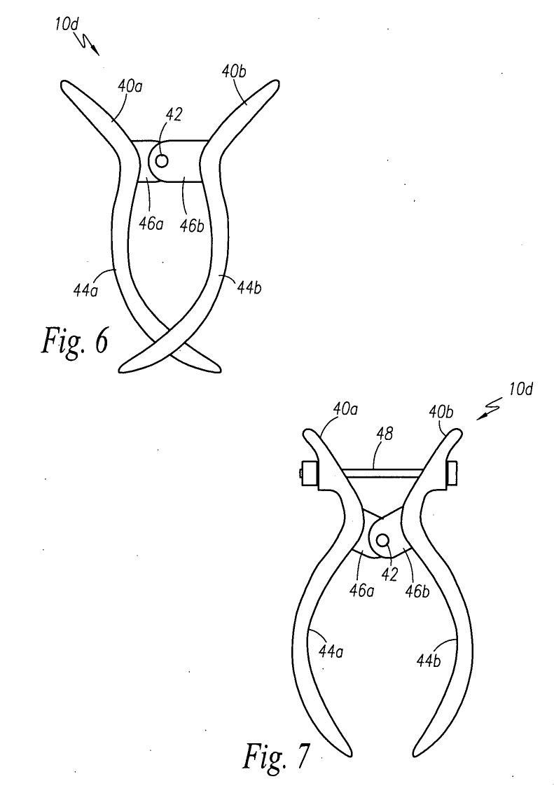

FIG. 6 is an end view of the animal trap 10d showing the arms 44a and 44b in a closed position. FIG. 7 is an end view of the animal trap 10d illustrating a closure limiting screw 48. The limiting screw 48 is mounted between levers 40a and 40b. Without limiting screw 48, the arms 44a and 44b may crush an animal when biased to the closed position. The limiting screw 48 is adjustable to prevent complete closure of the arms 44a and 44b, thereby resulting in arms 44a and 44b securely holding but not injuring an animal. However, limiting screw 48 is also selectively adjustable so as to allow arms 44a and 44b to be biased in such a manner that an entrapped animal therebetween may be deprived of life if desired by user.

While the animal trap 10 has been described as having a coil spring 22 or 50, the trap 10 may also utilize a leaf or “V” spring, and the spring may be fabricated of metal or plastic. In addition, while the animal trap 10 has been described in terms of a mouse trap, the trap 10 may be scaled for various animals or rodents, for example, rats, squirrels, and the like, and any trap having cupped members biased towards a closed position, and held apart by a trigger, is intended to come within the scope of the present invention. The animal trap 10 may further be used in a multiplicity of attitudes, for example, on a flat floor, horizontally on a wall, vertically on a wall, on a ceiling, on a tree limb, and the like.

### 2. Operation of the Preferred Embodiment

To use the present invention, user pulls and holds opposing cupped members 12 and 14 to an opened position and inserts trigger 28 horizontally between opposing cupped members 12 and 14. The trigger 28 is adapted for holding the cupped members 12 and 14 in an opened position. User next withdraws the screw 22 from the nut 54 to a degree which allows the diametrical measure of displacement of the arms 12a-12e to be reduced upon closing of the animal trap 10. In the event user desires to hold an animal within the trap 10 without causing injury or death thereto, user advances the screw 22 to a degree which allows a greater diametrical measure of displacement of the arms 12a-12e upon closing of the animal trap 10.

The use of the present invention allows for the capture of an animal or rodent without causing harm, injury, or death thereto.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be broadly limited only by the following Claims.

What is claimed is:

1. An animal trap comprising:
opposing cupped members;
at least one hinge, said hinge is mounted between said opposing cupped members; and
a trigger, said trigger is adapted to hold said opposing cupped members to an opened position, whereupon release of said trigger, said opposing cupped members are adapted to snap to a closed position, thereby trapping an animal therebetween.

2. The animal trap of claim 1, wherein said cupped members comprise two sets of curved arms, wherein said two sets of arms comprise a first set of arms and a second set of arms, said first set of arms is attached to a first backbone and said second set of arms is attached to a second backbone.

3. The animal trap of claim 2, wherein said first backbone and said second backbone are adjacently positioned, said first backbone is adapted to cause said first set of arms to open or close together, and said second backbone is adapted to cause said second set of arms to open or close together.

4. The animal trap of claim 3, wherein said first set of arms and said second set of arms are hingedly connected via said hinge to allow for the opening and closing of said first set of arms and said second set of arms, said hinge comprises end pieces between which said first backbone and said second backbone are hingedly mounted via pins.

5. The animal trap of claim 2, further comprising an adjustment mechanism, said adjustment mechanism is adapted to bias said first set of arms and said second set of arms towards a closed position.

6. The animal trap of claim 5, wherein said adjustment mechanism is adapted for adjustably setting and for selectively controlling hinged displacement or a diametrical measure of displacement of said first set of arms and said second set of arms in the closed position, thereby allowing a user to control whether an entrapped animal is deprived of life or harmlessly captured.

7. The animal trap of claim 5, wherein said adjustment mechanism comprises a first lever attached to said first backbone and a second lever attached to said second backbone, said first lever and said second lever includes a spring being suitably held therebetween, thereby facilitating cooperation of said first lever, said second lever and said spring to bias said first set of arms and said second set of arms towards a closed position.

8. The animal trap of claim 7, wherein said spring is captive over a screw, said screw provides a means for adjustably setting hinged displacement of said first set of arms and said second set of arms between an opened position and a closed position.

9. The animal trap of claim 8, wherein said screw is adapted to allow for selective control of a diametrical measure of displacement of said first set of arms and said second set of arms in the closed position, said screw threadedly engages a nut being mounted behind said second lever, said screw is advanced into said nut in order to allow a greater diametrical measure of displacement of said first set of arms and said second set of arms upon closing of the animal trap, and wherein said screw is withdrawn from said nut to reduce the diametrical measure of displacement of said first set of arms and said second set of arms upon closing of the animal trap, the animal trap is therefore selectively adjustable to limit injury to an animal caught therein.

10. The animal trap of claim 1, wherein said trigger is held horizontally between one arm of said first set of arms and one opposing arm of said second set of arms, wherein each end of said trigger resides in a dimple formed along an inner sidewall of both said one arm and said one opposing arm in order to provide said trigger with a stable position, said trigger is adapted for holding said first set of arms and said second set of arms in an opened position which is releasable to a closed position when an animal is positioned between said first set of arms and said second set of arms and where the animal causes contact or engagement with said trigger, or when said trigger slips, breaks, or is eaten through.

11. The animal trap of claim 2, wherein each of said first set of arms and each of said second set of arms include a dimple formed along an inner sidewall thereof for receiving a respective end of said trigger in order to provide said trigger with a stable position, said trigger is adapted for holding said first set of arms and said second set of arms in an opened position which is releasable to a closed position when an animal is positioned between said first set of arms and said second set of arms and where the animal causes contact or engagement with said trigger, or when said trigger slips, breaks, or is eaten through.

12. The animal trap of claim 1, wherein said opposing cupped members are each defined of a one-piece jaw, wherein each said one-piece jaw defines an arcuate shape.

13. An animal trap comprising:
opposing cupped members, wherein said cupped members comprise two sets of curved arms, wherein said two sets of curved arms comprise a first set of arms and a second set of arms, said first set of arms is attached to a first backbone and said second set of arms is attached to a second backbone, wherein said first backbone and said second backbone are adjacently positioned, said first backbone is adapted to cause said first set of arms to open or close together, and said second backbone is adapted to cause said second set of arms to open or close together;
a pair of hinges, said pair of hinges is mounted between said opposing cupped members or said first set of arms and said second set of arms, said first set of arms and said second set of arms are hinged via said pair of hinges to allow for the opening and closing of said first set of arms and said second set of arms, said pair of hinges comprises end pieces between which said first backbone and said second backbone are hingedly mounted via pins; and
a trigger, said trigger is adapted to hold said opposing cupped members to an opened position, whereupon release of said trigger, said opposing cupped members are adapted to snap to a closed position, thereby trapping an animal therebetween.

14. The animal trap of claim 13, wherein said first set of arms has a proximal arm and a distal arm defining a greater curvature than the remaining arms of said first set of arms, and said second set of arms has a proximal arm and a distal arm defining a greater curvature than the remaining arms of said second set of arms.

15. An animal trap comprising:
opposing arms, said opposing arms are adapted for securely holding an animal therebetween, said opposing arms each extend upwardly into a lever, said opposing arms are connected by hinge portions;
a pin, said pin extends through said hinge portions, and a spring resides over said pin, said spring is adapted to bias said opposing arms into a closed position; and
a trigger, said trigger is adapted for holding said opposing arms in an opened position.

16. The animal trap of claim 15, wherein said trigger is releasable when an animal is positioned between said opposing arms and where the animal causes contact or engagement with said trigger, or when said trigger slips, breaks, or is eaten through, thereby actuating said opposing arms into a closed position.

17. The animal trap of claim 16, wherein said trigger defines a finger and an integral, elongated stem extending perpendicularly therefrom, said trigger includes an arcuate-shaped brace molded integral to said stem below said finger, said finger is adapted to be inserted within an aperture defined through a first hinge portion of said hinge portions, said brace includes opposing ends adapted to engage an inner sidewall of each said opposing arms, said brace of said trigger functions to temporarily lock said opposing arms in an opened position, whereupon contact or engagement by an animal with said trigger actuates release of said finger from said aperture of said first hinge portion, and actuates disengagement by said brace from said opposing arms, thereby causing said spring to immediately bias said opposing arms into a closed position.

18. The animal trap of claim 16, wherein said trigger is held horizontally between said opposing arms in order to provide said trigger with a stable position, said opposing arms are released to a closed position when said trigger slips, breaks, or is eaten through, or is engaged or contacted by an animal.

19. The animal trap of claim 15, further comprising:
an adjustment mechanism, said adjustment mechanism is adjustable for selectively controlling hinged displacement or a diametrical measure of displacement of said opposing arms, thereby allowing said opposing arms to securely hold an animal therebetween and to allow a user to control whether an entrapped animal is deprived of life or harmlessly captured.

20. The animal trap of claim 19, wherein said adjustment mechanism comprises a closure limiting screw, said closure limiting screw is mounted between levers of said opposing arms.
